(19) United States
(12) Patent Application Publication
(10) Pub. No.: US 2025/0356556 A1
(43) Pub. Date: Nov. 20, 2025

(54) IMAGE GENERATING SYSTEM

(71) Applicant: KYOCERA Document Solutions Inc., Osaka (JP)

(72) Inventors: Yuya Okazaki, Osaka (JP); Kenichi Katsura, Osaka (JP); Naomichi Higashiyama, Osaka (JP)

(21) Appl. No.: 19/205,837

(22) Filed: May 12, 2025

(30) Foreign Application Priority Data
May 20, 2024 (JP) 2024-082127

(51) Int. Cl. G06T 11/60

(52) U.S. Cl. CPC G06T 11/60

(57) ABSTRACT

An image generating system includes a target image acquiring unit, a command detecting unit, a user prompt converting unit, and a process executing unit. The target image acquiring unit is configured to acquire as a target image a document image of a document. The command detecting unit is configured to (a) detect in the document image an additionally-written command additionally described to the document and (b) determine a user prompt and a process target area corresponding to the additionally-written command in the target image. The user prompt converting unit is configured to acquire a keyword in association with the user prompt, and add the keyword to the user prompt. The process executing unit is configured to (a) acquire using an image generation model a generated image corresponding to the user prompt added the keyword, and (b) insert the generated image to the process target area.

### CROSS-REFERENCE TO RELATED APPLICATIONS

This application relates to and claims priority rights from Japanese Patent Application No. 2024-082127, filed on May 20, 2024, the entire disclosures of which are hereby incorporated by reference herein.

### BACKGROUND

### 1. Field of the Present Disclosure

The present disclosure relates to an image generating system.

### 2. Description of the Related Art

An automatic coloring device performs coloring of a line drawing on the basis of hint information, and the hint information is information that specifies a color using a dot, a line or the like.

However, the aforementioned automatic coloring device can color an object in a target image, but hardly adds a new image object desired by a user.

### SUMMARY

An image generating system according to an aspect of the present disclosure includes a target image acquiring unit, a command detecting unit, a user prompt converting unit, and a process executing unit. The target image acquiring unit is configured to acquire as a target image a document image of a document. The command detecting unit is configured to (a) detect in the document image an additionally-written command additionally described to the document and (b) determine a user prompt and a process target area corresponding to the additionally-written command in the target image. The user prompt converting unit is configured to acquire a keyword in association with the user prompt, and add the keyword to the user prompt. The process executing unit is configured to (a) acquire using an image generation model a generated image corresponding to the user prompt added the keyword, and (b) insert the generated image to the process target area.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image generating system in an embodiment of the present disclosure;

FIG. 2 shows a diagram that indicates an example of a target image;

FIG. 3 shows a diagram that indicates an example of a generated image; and

FIG. 4 shows a diagram that indicates an example of a target image in which the generated image shown in FIG. 3 has been inserted.

### DETAILED DESCRIPTION

Hereinafter, an embodiment according to an aspect of the present disclosure will be explained with reference to drawings.

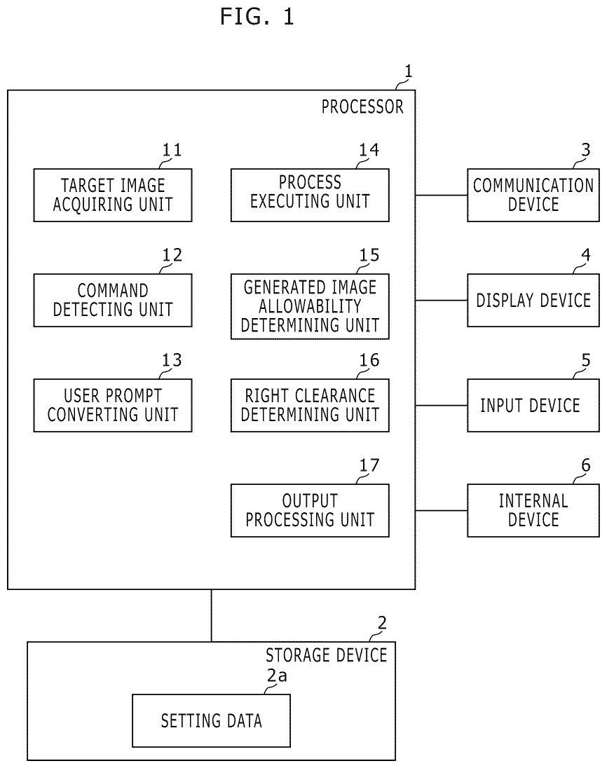

FIG. 1 shows a block diagram that indicates a configuration of an image generating system in an embodiment of the present disclosure. An image generating system shown in FIG. 1 is an information processing apparatus such as personal computer, or an electronic apparatus such as digital camera or image forming apparatus (scanner, multi function peripheral or the like), and includes a processor 1, a storage device 2, a communication device 3, a display device 4, an input device 5, an internal device 6 and the like.

The processor 1 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 2, executes the program with the CPU, and thereby acts as sorts of processing units. Further, the processor 1 may include an ASIC (Application Specific Integrated Circuit) that acts as a specific processing unit.

The storage device 2 is a non-volatile storage device such as flash memory, and stores the image processing program and data required for a process mentioned below. In the storage device 2, setting data 2a is stored. The setting data 2a includes data of a relationship between an additionally-written command and a process to be performed, or the like.

The communication device 3 is a device that performs data communication with an external device, such as network interface or a peripheral device interface. The display device 4 is a device that displays sorts of information to a user, such as a display panel of a liquid crystal display. The input device 5 is a device that detects a user operation, such as keyboard or touch panel.

The internal device 6 is a device that performs a specific function. For example, if this image generating system is an image forming apparatus such as multi function peripheral, the internal device 6 is an image scanning device that optically scans a document image from a document, a printing device that prints an image on a print sheet, or the like.

Here, as the aforementioned processing units, the processor 1 acts as a target image acquiring unit 11, a command detecting unit 12, a user prompt converting unit 13, a process executing unit 14, a generated image allowability determining unit 15, a right clearance determining unit 16, and an output processing unit 17.

The target image acquiring unit 11 acquires as a target image (image data) a document image of a document from the storage device 2, the communication device 3, the internal device 6 or the like, and stores the target image into the RAM or the like. For example, this document is a print product outputted by a printing device, and this document image is an image obtained by scanning such document using an image scanning device. For example, this document is a business form.

The command detecting unit 12 (a) detects in the document image an additionally-written command additionally described to the document and (b) determines a user prompt and a process target area corresponding to the additionally-written command in the target image.

For example, the command detecting unit 12 performs a character recognition process for the target image, detects each string (text data) in the target image and determines a position of it, determines a string registered as an additionally-written among command the detected string, determines as the process target area a figure of a predetermined shape (here, a rectangular frame) adjacent to the determined string, and determines as the user prompt a string adjacent to the determined string.

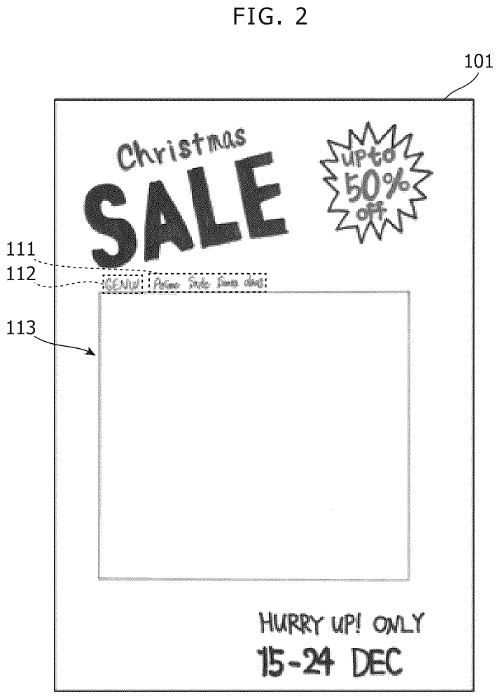

FIG. 2 shows a diagram that indicates an example of a target image. In the target image 101 shown in FIG. 2, for example, a character recognition process is performed for the target image 101, thereby, strings “Christmas”, “SALE”, “upto”, “50%”, “off”, “GENW”, “Anime Santa clause”, “HURRYUP!ONLY”, “15-24 DEC” and the like are detected and positions of the strings are determined. Among them, the string 111, i.e. “GENW” registered as an additionally-written command is determined, and the string 112, i.e. “Anime Santa clause” adjacent to the string 111 is determined as a user prompt, and a rectangular frame adjacent to the string 111 is determined as a process target area.

Here, the additionally-written command “GENW” specifies a process to generate an image on the basis of the user prompt using an image generation model, and insert the generated image to the process target area (after zooming and/or trimming it if required).

The user prompt converting unit 13 acquires a keyword in association with the determined user prompt, and adds the acquired keyword to the user prompt. The user prompt converting unit 13 may add all of the acquired keyword(s), and may add only a keyword selected by a user among the acquired keyword(s). In this case, for example, the acquired keyword is displayed on the display device 4, a user operation to select a keyword by a user is performed to the input device 5, and the user prompt converting unit 13 determines the keyword selected by the user on the basis of the user operation.

Specifically, the user prompt converting unit 13 acquires a keyword in association with the user prompt (hereinafter, called “association keyword”) using a machine-learned large language model such as PALM or ChatGPT. For example, using the communication device 3, the user prompt converting unit 13 accesses a server of a machine-learned large language model such as PALM or ChatGPT, inputs a prompt added instruction words (e.g. “Please teach a keyword in association with”) and the user prompt, and acquires an association keyword from the large language model.

For example, as shown in FIG. 2, the association keywords “Christmas, present, snow” are acquired by the large language model from the user prompt “Anime Santa Claus” acquired from the target image 101, and the user prompt is converted to “Anime, Santa Claus, Christmas, present, snow”.

The process executing unit 14 (a) acquires using a machine-learned image generation model such as StableDiffusion a generated image corresponding to the user prompt added the keyword, and (b) inserts the generated image to the process target area.

This image generation model may be installed in the process executing unit 14 or may be installed on an external server. If the image generation model is installed on an external server, then using the communication device 3, the process executing unit 14 accesses the server of the image generation model and acquires the generated image from the server.

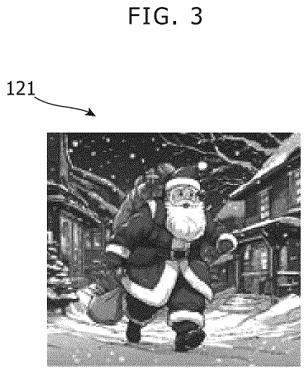

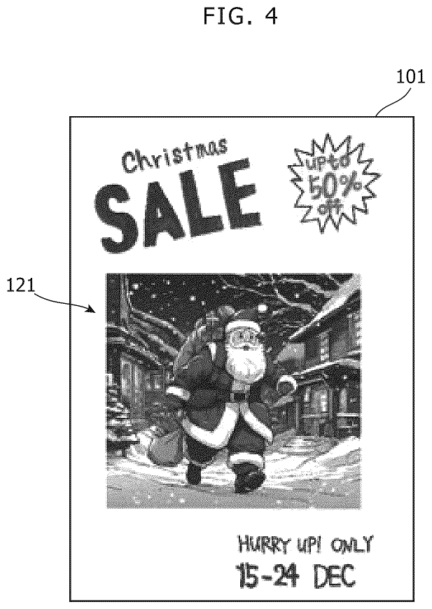

FIG. 3 shows a diagram that indicates an example of a generated image. FIG. 4 shows a diagram that indicates an example of a target image in which the generated image shown in FIG. 3 has been inserted. If a generated image 121 shown in FIG. 3 for example is acquired correspondingly to the user prompt, the process executing unit 14 deletes the additionally-written command and the user prompt (the strings 111 and 112) and the process target area (the rectangular frame 113) in the target image 101, and thereafter, attaches the generated image 121 to a position of the process target area as shown in FIG. 4, for example.

If the image generation model designates a specific language type (e.g. English) as a language type of the prompt and the user prompt is not described in the specific language type, the user prompt converting unit 13 may translate the user prompt to the specific language type and the process executing unit 14 may acquire a generated image corresponding to the translated user prompt.

The generated image allowability determining unit 15 determines whether the generated image is ethically allowed or not.

For example, using the communication device 3, the generated image allowability determining unit 15 acquires probability levels that an improper content of specific categories (adult, spoof, medical, violence and racy) is included in the generated image with SafeSearch of Google, and determines whether the generated image is ethically allowed or not on the basis of the probability levels. If it is determined that the generated image is not ethically allowed, the process executing unit 14 discards the generated image.

It should be noted that the generated image allowability determining unit 15 is installed if required, and the generated image allowability determining unit 15 may not be installed.

The right clearance determining unit 16 determines a probability of whether the generated image conflicts at least one of a copyright, a trademark right and a portrait right or not.

For example, using the communication device 3, the right clearance determining unit 16 performs image searching of the user prompt with Webdetection of Google, and acquires an image as a result of the image searching, and if a similarity between the acquired image and the generated image exceeds a predetermined threshold value, the right clearance determining unit 16 determines a probability of that the generated image conflicts at least one of a copyright, a trademark right and a portrait right. If it is determined that there is a probability that the generated image conflicts at least one of a copyright, a trademark right and a portrait right, the process executing unit 14 discards the generated image.

It should be noted that the right clearance determining unit 16 is installed if required, and the right clearance determining unit 16 may not be installed.

The output processing performs outputting (printing, data transmission, saving to the storage device, or the like) of the target image after the aforementioned process.

The following part explains a behavior of the aforementioned image generating system.

When the target image acquiring unit 11 acquires a target image in accordance with a user operation or the like, the command detecting unit 12 (a) detects in the target image an additionally-written command additionally described to a document, and (b) determines a user prompt and a process target area corresponding to the additionally-written command in the target image.

Subsequently, the user prompt converting unit 13 acquires a keyword in association with the determined user prompt and adds the acquired keyword to the user prompt.

Subsequently, correspondingly to the determined additionally-written command, the process executing unit 14 acquires a generated image corresponding to the user prompt added the association keyword using an image generation model.

Here, the generated image allowability determining unit 15 determines whether the generated image is ethically allowed or not, and the right clearance determining unit 16 determines a probability of whether the generated image conflicts at least one of a copyright, a trademark right and a portrait right or not on the basis of the user prompt (text) added the association keyword.

If it is determined that the generated image is not ethically allowed or if it is determined that there is a probability that the generated image conflicts at least one of a copyright, a trademark right and a portrait right, then the process executing unit 14 discards the generated image and displays an error message on the display device 4.

Contrarily, if the generated image is not ethically allowed or if it is determined that there is not a probability that the generated image conflicts at least one of a copyright, a trademark right and a portrait right, then the process executing unit 14 inserts the generated image to the process target area. Afterward, the output processing unit 17 performs outputting of the target image to which the generated image has been inserted.

As mentioned, in the aforementioned embodiment, the command detecting unit 12 (a) detects in the document image an additionally-written command additionally described to the document and (b) determines a user prompt and a process target area corresponding to the additionally-written command in the target image. The user prompt converting unit 13 acquires a keyword in association with the determined user prompt, and adds the acquired keyword to the user prompt. The process executing unit 14 (a) acquires using an image generation model a generated image corresponding to the user prompt added the keyword, and (b) inserts the generated image to the process target area.

Consequently, correspondingly to the target image, a new image object desired by a user (i.e. aforementioned generated image) is automatically and properly generated and added.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in FIG. 2, only one additionally-written command exists in the target image. Alternatively, plural additionally-written commands (and corresponding plural user prompts and process target areas) may exist in the target image.

What is claimed is:

1. An image generating system, comprising:
a target image acquiring unit configured to acquire as a target image a document image of a document;
a command detecting unit configured to (a) detect in the document image an additionally-written command additionally described to the document and (b) determine a user prompt and a process target area corresponding to the additionally-written command in the target image;
a user prompt converting unit configured to acquire a keyword in association with the user prompt, and add the keyword to the user prompt; and
a process executing unit configured to (a) acquire using an image generation model a generated image corresponding to the user prompt added the keyword, and (b) insert the generated image to the process target area.

2. The image generating system according to claim 1, wherein the user prompt converting unit acquires the keyword from the user prompt using a machine-learned large language model.

3. The image generating system according to claim 1, further comprising a right clearance determining unit configured to determine a probability of whether the generated image conflicts at least one of a copyright, a trademark right and a portrait right or not;
wherein the process executing unit discards the generated image if it is determined that the generated image conflicts at least one of a copyright, a trademark right and a portrait right.

4. The image generating system according to claim 1, further comprising a generated image allowability determining unit configured to determine whether the generated image is ethically allowed or not;
wherein the process executing unit discards the generated image if it is determined that the generated image is not ethically allowed.
